(19) United States
(12) Patent Application Publication
(10) Pub. No.: US 2026/0119960 A1
(43) Pub. Date: Apr. 30, 2026

(54) METHOD FOR PROTECTING USE OF MACHINE LEARNING MODULES, AND PROTECTION SYSTEM

(71) Applicant: Siemens Aktiengesellschaft, München (DE)

(72) Inventors: Anja von Beuningen, Erfurt (DE); Michel Tokic, Tettnang (DE); Boris Scharinger, Fürth (DE)

(21) Appl. No.: 18/719,102

(22) PCT Filed: Nov. 22, 2022
(86) PCT No.: PCT/EP2022/082854

§ 371 Date: Jun. 12, 2024

(30) Foreign Application Priority Data
Dec. 17, 2021 (EP) 21215721.8

(51) Int. Cl. G06N 20/00

(52) U.S. Cl. CPC G06N 20/00

(57) ABSTRACT

A transformation function for executing a signal transformation that is dependent on a transformation parameter to protect use of a machine learning module is provided. Furthermore, a key specification specific to use of the machine learning module by a machine controller is read in. Input signals for training the machine learning module are transformed by the transformation function into transformed input signals, the key specification is used as the transformation parameter. The machine learning module is trained based on the transformed input signals. The trained machine learning module is then transmitted to the machine controller. The machine controller transforms operating signals of the machine into transformed operating by the transformation function, wherein the key specification is used as the transformation parameter. The transformed operating signals are supplied to the trained machine learning module, and the machine is controlled based on control signals derived from the transformed operating signals.

### CROSS-REFERENCE TO RELATED APPLICATIONS

This application is a national stage of PCT Application No. PCT/EP2022/082854, having a filing date of Nov. 22, 2022, claiming priority to EP Application No. 21215721.8, having a filing date of Dec. 17, 2021, the entire both contents of which are hereby incorporated by reference.

### FIELD OF TECHNOLOGY

The following relates to a method for protecting use of machine learning modules, and protection system.

### BACKGROUND

Complex machines, such as robots, engines, manufacturing plants, machine tools, gas turbines, wind turbines or motor vehicles generally require complex control and monitoring procedures for productive and stable operation. For this purpose, machine learning techniques are often used in modern machine control systems. For example, a neural network as a control model can be trained to control a machine in an optimized way.

However, training neural networks or other machine learning modules to control complex machines is often very time-consuming. As a rule, large amounts of training data, significant computing resources and a great deal of specific expert knowledge are required. There is therefore great interest in protecting trained machine learning modules against uncontrolled or unauthorized dissemination or use, in detecting theft and/or in ensuring that a machine to be controlled is only controlled by authorized machine learning modules.

It is known to identify neural networks by providing their neural weights with a unique digital watermark before they are made available. Using the watermark, an existing neural network can then be checked to determine whether it originates from the user of the watermark. However, the above method presupposes access to the neural weights of the neural network. In addition, additional measures are often required to prevent or at least make it more difficult for unauthorized users to use the neural network or to change the watermark without authorization.

### SUMMARY

An aspect relates to a method for protecting the use of a machine learning module and a corresponding protection system, which provide better protection of its use.

According to embodiments of the invention, to protect the use of a machine learning module by which control signals for controlling the machine can be derived from operating signals of a machine, a transformation function is provided for executing a signal transformation that is dependent on a transformation parameter. Furthermore, a key specification specific to use of the machine learning module by a machine controller is read in. Input signals for training the machine learning module are thereby transformed by the transformation function into transformed input signals, wherein the key specification is used as a transformation parameter. The machine learning module is trained on the basis of the transformed input signals. The trained machine learning module is then transferred to the machine controller. Operating signals of the machine are transformed by the machine controller by the transformation function into transformed operating signals, wherein the key specification is used as a transformation parameter. The transformed operating signals are supplied to the trained machine learning module and the machine is controlled on the basis of control signals derived from the transformed operating signals.

For the implementation of the method according to embodiments of the invention a protection system, a computer program product (non-transitory computer readable storage medium having instructions, which when executed by a processor, perform actions) and a machine-readable, desirably non-volatile, storage medium are provided.

In embodiments, the method according to the invention and the protection system according to embodiments of the invention can be embodied or implemented, for example, by one or more computers, processors, application specific integrated circuits (ASIC), digital signal processors (DSP) and/or so-called Field Programmable Gate Arrays (FPGA). In addition, the method according to embodiments of the invention can be carried out at least partially in a cloud and/or in an edge computing environment.

Embodiments of the invention can be seen in the fact that a machine learning module to be protected can be easily coupled to a use. In embodiments, the machine learning module can be trained or executed for a specific use. In many cases, this ensures that a machine is controlled only by an authorized machine learning module and/or that a machine learning module is only used by authorized users. In addition, embodiments of the invention are flexibly applicable and in particular not limited to artificial neural networks.

According to an embodiment of the invention, the transformation function can perform a homomorphic and/or holomorphic signal transformation. In embodiments, the transformation function itself may be a homomorphic and/or holomorphic, injective function. A homomorphic function is known to map mathematical, numerical and/or logical operations on data to corresponding operations of the transformed data. In the case of a simple operation, in particular f(x*y)=f(x) * f(y) applies, where the “*” operation symbol on the left-hand side of the equation designates an operation on the data to be transformed and on the right-hand side designates an operation on the transformed data. Thus, structures of operations are preserved in homomorphic transformations. Holomorphic transformations, i.e., transformations that can be differentiated in a complex manner, also preserve essential structures of the data to be transformed, e.g., in conformant mappings. Due to the structure-preserving properties of homomorphic and/or holomorphic transformations, many patterns in operating signals remain accessible to recognition and processing by machine learning modules even after the transformation.

According to an embodiment of the invention, the key specification may be a specification that is specific to the machine controller, for a control platform of the machine controller and/or for a user of the machine controller. In this way, the transformation function and thus the training of the machine learning module can be individualized specifically for the machine controller, for the control platform and/or for the user.

In embodiments, the key specification can comprise a digital fingerprint, a MAC address (MAC: Media Access Control), a user password, a hardware identifier, a serial number, a machine certificate, a parameterization and/or a system property of the machine controller or be derived from it by a key generator.

In an embodiment, an operating signal of the machine can be supplied to the key generator. The key specification can then be generated by the key generator as a function of the operating signal supplied. In embodiments, one or more operating signals temporally prior to a current operating signal can be supplied to the key generator in order to influence the generation of the key specification. In this way, the key specification can be generated in a context-dependent manner, which makes it much harder for unauthorized persons to gain access to it. Moreover, it turns out that in many cases training of the machine learning module is not significantly impaired by an operating-signal-dependent key generation.

According to an embodiment of the invention, a training success rate of the machine learning module can be determined continuously. The key generator can then be trained by a machine learning procedure to generate a key specification that optimizes the training success rate of the machine learning module. A respective training success rate can be determined, for example, by measuring or determining by simulation the performance of the machine controlled by output signals of the machine learning module. The performance that is measured or determined by simulation can then be taken into account in a cost function for training the key generator. In an embodiment, the machine learning module and the key generator can be trained together.

According to a further embodiment of the invention, a predefined test input signal and a predefined digital watermark can be read in. The test input signal can be transformed into a transformed test input signal by the transform function. The machine learning module can then be trained to reproduce the digital watermark on the basis of the transformed test input signal. Furthermore, the transformed test input signal can be supplied to the machine learning module by the machine controller. Accordingly, it can be checked whether a resulting output signal of the machine learning module contains the digital watermark. Depending on the test result, the machine can then be controlled. In embodiments, in the event of a negative test result, an alarm signal can be transmitted to a creator or user of the machine learning module. In an embodiment, the testing of the digital watermark can be performed in a hardware module separate from the machine controller.

According to a further embodiment of the invention, the machine learning module and the transformation function can be encapsulated in a software container, in particular in a key- or signature-protected software container. The software container may be designed such that the machine learning module or the transformation function loses its function if the software container is separated.

According to a further embodiment of the invention, the operating behavior of the machine can be monitored, and upon detection of a change in the operating behavior, an alarm signal can be output, in particular to a creator or user of the machine learning module. Use of the machine learning module without the transformation function, with an incorrect transformation function or with an incorrect key specification usually results in input signals being supplied to the machine learning module that the machine learning module is not trained to process. Thus, controlling the machine based on the resulting output signals would generally give rise to a malfunction of the machine. In an embodiment, such control errors can be avoided in many cases. In addition, a creator or user of the machine learning module can be informed about the use of an unauthorized machine learning module.

### BRIEF DESCRIPTION

Some of the embodiments will be described in detail, with references to the following Figures, wherein like designations denote like members, wherein:

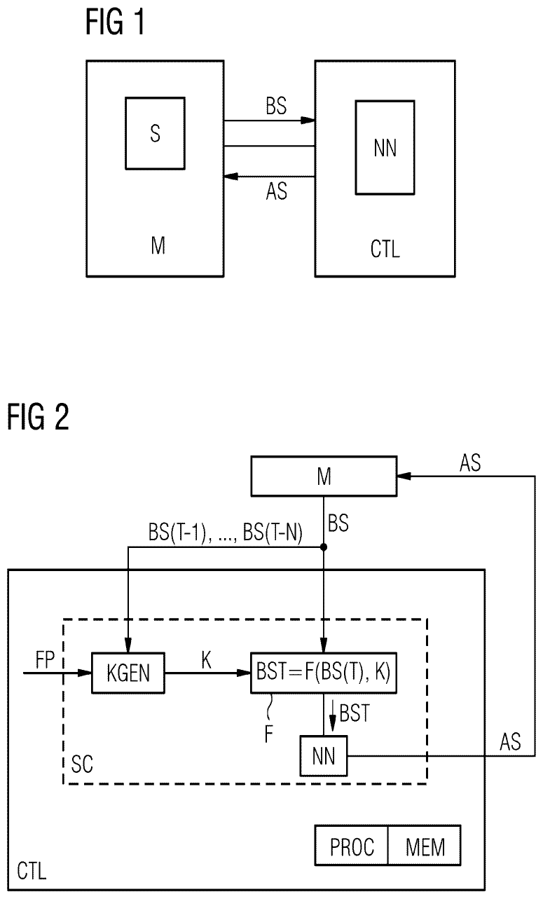

FIG. 1 shows a control of a machine by a machine learning module;

FIG. 2 shows an operation of a machine learning module protected; and

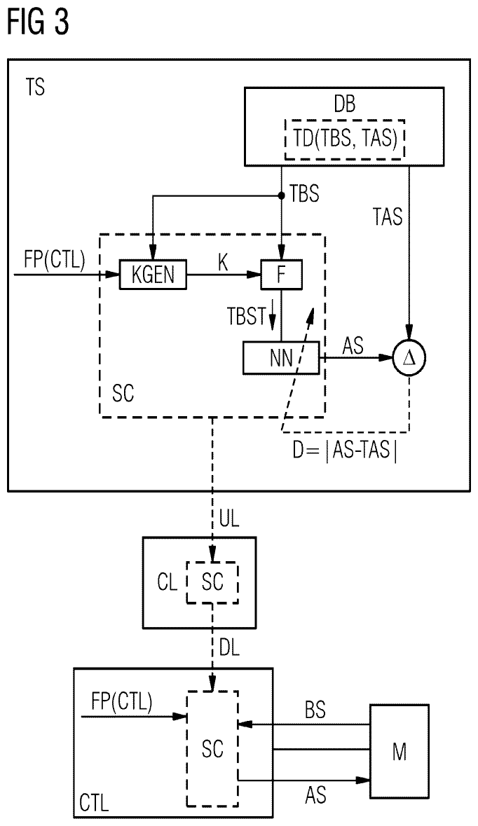

FIG. 3 shows a protection system for a machine learning module.

### DETAILED DESCRIPTION

FIG. 1 illustrates control of a machine M by a trained machine learning module NN in a schematic representation. In embodiments, the machine M can be or comprise a robot, an engine, a manufacturing plant, a machine tool, a turbine, an internal combustion engine and/or a motor vehicle. For the present exemplary embodiment, it is assumed that the machine M is a manufacturing robot.

The machine M is controlled by a machine controller CTL connected to it. The latter is shown in FIG. 1 externally to the machine M. Alternatively, the machine controller CTL can also be fully or partially integrated into the machine M.

The machine M has a sensor system S, which continuously measures the operating parameters of the machine M as well as other measured values. The measured values determined by the sensor system S are transferred from the machine M to the machine controller CTL together with other operating data of the machine M in the form of operating signals BS.

The operating signals BS comprise in particular sensor data and/or measurement values of the sensor system S, control signals of the machine M and/or status signals of the machine M. The status signals specify in each case an operating state of the machine M or of one or more of its components, over time.

In embodiments, the operating signals BS can be used to quantify a power, a rotation speed, a torque, a movement speed, a force exerted or acting, a temperature, a pressure, a current resource consumption, available resources, a pollutant emission, vibrations, wear and/or load on the machine M or on components of the machine M. In an embodiment, the operating signals BS are each represented by one or more numerical data vectors and transferred in this form to the machine controller CTL.

The machine controller CTL additionally has a trained machine learning module NN for controlling the machine M. The machine learning module NN is trained to output, on the basis of a supplied input signal, an output signal by which the machine M can be controlled in an optimized manner. For training such a machine learning module NN, a wide range of efficient machine learning methods is available, in particular methods for reinforcing learning, which is often also called reinforcement learning. The training of the machine learning module NN is discussed in more detail below. The machine learning module NN can be implemented in particular as an artificial neural network.

To control the machine M, output signals AS, e.g., in the form of numerical data vectors, are derived from the operating signals BS using the trained machine learning module NN. The output signals AS or signals derived from them are then transferred as control signals to the machine M in order to control the latter in an optimized manner.

FIG. 2 illustrates an operation of a machine learning module NN protected according to an embodiment of the invention for controlling the machine M. As already mentioned above, the machine M is controlled by the machine controller CTL.

To protect the machine learning module NN, the machine controller CTL has a transformation function F coupled to an input layer of the machine learning module NN, and a key generator KGEN. The machine controller CTL additionally has one or more processors PROC for executing method steps according an embodiment of the invention and one or more memories MEM for storing data to be processed.

The transformation function F in the present exemplary embodiment performs a signal-modifying homomorphic signal transformation. In an embodiment, the transformation function F itself is a homomorphic function. Alternatively, or in addition, the transformation function F may comprise a signal-modifying holomorphic, i.e., a complex differentiable function, or may itself be a holomorphic function. In an embodiment, the signal transformation to be performed is injective.

A wide range of homomorphic or holomorphic functions are known for implementing such transformation functions. In embodiments, a linear function F=m*x+b=F(x, (m, b)) of a variable x with the parameters m and b (m not equal to 0) can be used. Alternatively, or in addition, the signal transformation can be or comprise a homogeneous transformation in which points in an e.g., 3-dimensional vector space are transformed by translation, rotation and/or scaling in a structure-preserving manner. In embodiments, a Denavit-Hartenberg transformation known from the field of robotics can be used.

According to embodiments of the invention, the homomorphic and/or holomorphic signal transformation implemented by the transformation function F depends on a transformation parameter K, which is passed to the transformation function F as an additional argument. In the example of a linear function above, the transformation parameter comprises the parameter pair (m, b).

As mentioned above, the machine controller CTL uses the trained machine learning module NN to derive control signals from operating signals BS of the machine M for optimized control of the machine M. Output signals AS of the trained machine learning module NN or signals derived from them are used as control signals. For reasons of clarity, it is assumed for the present exemplary embodiment that the machine M is controlled by the output signals AS.

The purpose of the transformation function F is to transform the operating signals BS into transformed operating signals BST in a way that makes it impossible or at least difficult for unauthorized persons to reproduce. Due to the homomorphy or holomorphy of the transformation function F, many operation patterns and correlations of the operating signals BS originating from the machine M are preserved in the transformed operating signals BST. Thus, these patterns and correlations can be learned by the machine learning module NN and mapped to control signals, in this case AS, optimized in this respect.

In order to individualize the signal transformation performed by the transformation function F, this is influenced by the transformation parameter K. In the present exemplary embodiment, the transformation parameter K is passed to the transformation function F together with a respective operating signal BS as an additional argument. Each transformed operating signal BST is thus obtained as a return value of the transformation function F as a function of the transformation parameter K according to BST=F(BS, K).

In order to individualize the signal transformation specifically for the use of the machine learning module NN by the machine controller CTL, a key specification that is specific to the machine controller CTL and/or its users is used as the transformation parameter K in the present exemplary embodiment. This is derived, inter alia, from a digital fingerprint FP of the machine controller CTL by a key generator KGEN. The digital fingerprint FP comprises data which is unique for the machine controller CTL, its users and/or for the machine M, for example a MAC address, a hardware identifier, a serial number, a machine certificate, configuration parameters, a user password, etc.

To control the machine M, its operating signals BS(T) related to a current time T are acquired by the machine controller CTL and passed to the transformation function F as an argument. Furthermore, earlier operating signals BS(T-1), BS(T-2), . . . , BS(T-N) together with the digital fingerprint FP are fed into the key generator KGEN, where N denotes a number of operating signals to be taken into account in the key generation. For N, a value of 0, 1, 2 or 5 can be chosen in particular.

From the digital fingerprint FP and the earlier operating signals BS(T-1), BS(T-2), . . . , BS(T-N) of the machine M, the key generator KGEN generates the key specification K specific to the machine controller CTL and/or its users and passes it as an additional argument to the transformation function F. The key generation can in particular use a logical operation, a numeric operation, a bit operation, a hash formation and/or so-called one-way functions. The additional influence on the key generation by the earlier operating signals BS(T-1), BS(T-2), . . . , BS(T-N) makes it difficult for unauthorized persons to gain access to the key specification K. Incidentally, it turns out that training of the machine learning module NN is in many cases not significantly affected by this influence.

The transformation function F transforms each current operating signal BS(T) as a function of the key specification K into a current transformed operating signal BST=F(BS(T), K). The respective transformed operating signal BST is then fed into the trained machine learning module NN as an input signal. As explained in more detail below, the machine learning module NN is specifically trained to derive output signals AS from the operating signals transformed by the transformation function F for the optimized control of the machine M. These output signals AS of the trained machine learning module NN are transferred to the machine M in the present exemplary embodiment in order to control it.

In order to protect the interfaces between the machine learning module NN and the transformation function F and between the transformation function F and the key generator KGEN against unauthorized access, the machine learning module NN together with the transformation function F and the key generator KGEN is encapsulated in a software container SC with key- and/or signature-based protection. The interfaces can be protected by encryption or obfuscation, for example. The software container is designed such that the machine learning module NN, the transformation function F and/or the key generator KGEN lose their function if the software container SC is separated.

FIG. 3 illustrates a protection system according to embodiments of the invention for a machine learning module NN.

The machine learning module NN, for example an artificial neural network, is trained in a training system TS to output an output signal AS, by which the machine M can be controlled in an optimized manner. The training is performed using a large amount of training data TD taken from a database DB. In the present exemplary embodiment, the training data TD contains pairs each consisting of a training operating signal TBS and an associated training output signal TAS, which are each represented as numerical data vectors. Each training output signal TAS represents a control signal by which the machine M is controlled in an optimized manner when the assigned training operating signal TBS is present. The training data TD can be determined, for example, from an operation of the machine M, from an operation of a machine similar thereto, or from a simulation of the machine M.

Training here shall be understood generally to mean an optimization of a mapping from an input signal of a machine learning module to an output signal thereof. This mapping is optimized according to predefined criteria that are learned and/or to be learned during a training phase. As suitable criteria, in control models in particular, the success of a control action can be used, or in prediction models a prediction error can be used. As a result of the training, in particular, network structures of neurons of a neural network and/or weights of connections between the neurons can be adjusted or optimized in such a way that the predefined criteria are satisfied as fully as possible. The training can thus be understood as an optimization problem.

A wide range of efficient optimization methods are available for such optimization problems in the field of machine learning, in particular gradient-based optimization methods, gradient-free optimization methods, back-propagation methods, particle swarm optimizations, genetic optimization methods and/or population-based optimization methods. In embodiments, trainable models can be artificial neural networks, recurrent neural networks, convolving neural networks, perceptrons, Bayesian neural networks, autoencoders, variational autoencoders, Gaussian processes, deep learning architectures, support vector machines, data-driven regression models, K-nearest-neighbor classifiers, physical models, and/or decision trees.

In the present case, to train the machine learning module NN, the transformation function F is connected upstream of it, as already indicated above. A key specification K generated by the key generator KGEN is supplied to the transformation function F as an additional argument. To generate the key specification K, a digital fingerprint FP(CTL) of the machine controller, in this case CTL, designated for executing the trained machine learning module NN, is supplied to the key generator KGEN. Furthermore, the key generator KGEN is supplied with training operating signals, as described above, which precede a training operating signal that is currently to be transformed by the transformation function F. The key specification K is generated from the digital fingerprint FP(CTL) by the key generator KGEN as a function of the earlier training operating signals TBS.

For training the machine learning module NN, the training operating signals TBS are supplied to the transformation function F together with the key specification K as arguments and transformed by the transformation function F into transformed training operating signals TBST. The transformed training operating signals TBST are supplied as input signals to the machine learning module NN to be trained.

In the course of the training, neural weights of the machine learning module NN are adjusted by one of the above-mentioned optimization methods in such a manner that the machine M is controlled in an optimized manner by the output signals AS derived from the transformed input signals TBST by the machine learning module NN. For this purpose, in the present exemplary embodiment, the output signals AS are compared with the associated training output signals TAS and a respective distance D between these signals is determined. For example, the distance D can be determined as a Euclidean distance between the representing data vectors, according to D=|AS-TAS|. As indicated in FIG. 3 by a dotted arrow, the distances D thus determined are fed back to the machine learning module NN. Its neuronal weights are then adjusted such that the distance D is minimized.

Alternatively, or in addition, a reinforcement learning method can be used for training the machine learning module NN. In this case, the machine M or a simulation of the machine M can be controlled by the output signals AS, wherein the performance of the machine M is continuously measured or otherwise determined. For example, the performance can be determined as a power, an efficiency, a throughput, an execution speed or other parameters relevant to the operation of the machine M. The neural weights of the machine learning module NN are then adjusted to optimize the performance.

In some embodiments, the key generator KGEN can itself be trained by a machine learning procedure to generate a key specification K that optimizes a training success rate of the machine learning module NN. The training success rate can be quantified in particular by the distance D or by the performance of the machine M.

In addition, the machine learning module NN can also be trained to reproduce a predefined digital watermark as an output signal AS when a test input signal that does not occur in the operating data of the machine M is fed in. This watermark can be used in a subsequent use or examination of the trained machine learning module NN to determine the origin of the machine learning module NN.

The trained machine learning module NN is encapsulated in the training system TS together with the transformation function F and with the key generator KGEN in a software container SC, as described above. By the connection of the machine learning module NN to the transformation function F and the key generator KGEN as well as by the training being specifically dependent on the digital fingerprint FP, the trained machine learning module NN is protected against unauthorized use or against use outside the machine controller CTL.

The software container SC with the protected machine learning module NN is transmitted from the training system TS by an upload UL into a cloud CL, in particular to an app store of the cloud CL.

The software container SC is downloaded from the cloud CL or its app store by a download DL by a user who wants to control the machine M using the protected machine learning module NN.

For this purpose, the software container SC is installed by the machine controller CTL in an edge computing environment and executed in a runtime environment of the edge computing environment. In this process a digital fingerprint FP(CTL) of the machine controller CTL is supplied to the key generator KGEN contained in the software container SC. Furthermore, the key generator KGEN, as described above, is supplied with earlier operating signals of the machine M to be controlled, in order to influence the derivation of the key specification K from the digital fingerprint FP(CTL).

To control the machine M, current operating signals BS of the machine M are fed into the transformation function F contained in the software container SC, to which the generated key specification K is also passed as an additional argument. The operating signals BST transformed by the transformation function F are then supplied to the trained machine learning module NN contained in the software container SC as input signals. The resulting output signals AS of the trained machine learning module NN are then transferred from the machine controller CTL as control signals to the machine M, as also described above.

Insofar as the machine learning module NN is trained in a specific way to derive control signals AS from the transformed operating signals BST, it can be assumed that the machine learning module NN cannot derive any meaningful control signals from untransformed operating signals BS. As the signal transformation is interlocked in an individual way with the machine learning module CTL, it is normally possible to ensure that the machine learning module NN is only used by authorized users or in machine controllers intended for the purpose. Due to the training-specific and application-specific entanglement of the machine learning module NN with the transformation function F, the active mechanisms running cannot be reconstructed or reversed by unauthorized persons, or at least only with great effort.

Although the present invention has been disclosed in the form of embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A computer-implemented method for protecting the use of a machine learning module, by which control signals for controlling a machine are derived from operating signals of the machine, wherein
a) providing a transformation function for performing a signal transformation as a function of a transformation parameter,
b) reading in a key specification specific to the use of the machine learning module by a machine controller,
c) transforming input signals for training the machine learning module by the transformation function into transformed input signals, wherein the key specification is used as a transformation parameter,
d) training the machine learning module on the basis of the transformed input signals,
e) transferring the trained machine learning module to the machine controller
f) transforming operating signals of the machine by the machine controller into transformed operating signals by the transformation function, wherein the key specification is used as a transformation parameter,
g) supplying the transformed operating signals to the trained machine learning module, and
h) controlling the machine on the basis of control signals derived from the transformed operating signals.

2. The method as claimed in claim 1, wherein the transformation function executes a homomorphic and/or holomorphic signal transformation.

3. The method as claimed in claim 1, wherein the key specification is a specification that is specific to the machine controller, for a control platform of the machine controller and/or for a user of the machine controller.

4. The method as claimed in claim 1, wherein the key specification comprises
a digital fingerprint,
a MAC address,
a user password,
a hardware identifier,
a serial number,
a machine certificate,
a parameterization and/or
a system property of the machine controller or is derived from it by a key generator.

5. The method as claimed in claim 4, wherein the key generator is supplied with an operating signal of the machine, and that the key specification is generated by the key generator as a function of the operating signal supplied.

6. The method as claimed in claim 4, wherein a training success rate of the machine learning module is determined, and that the key generator is trained by a machine learning procedure to generate a key specification that optimizes the training success rate of the machine learning module.

7. The method as claimed in claim 1,
wherein
a test input signal and a predefined digital watermark are read in,
that the test input signal is transformed by the transformation function into a transformed test input signal,
that the machine learning module is trained to reproduce the digital watermark on the basis of the transformed test input signal,
that the transformed test input signal is supplied to the machine learning module by the machine controller
that it is checked whether a resulting output signal of the machine learning module contains the digital watermark, and
that the machine is controlled depending on the test result.

8. The method as claimed in claim 1,
wherein
the machine learning module and the transformation function are encapsulated in a software container.

9. The method as claimed in claim 1,
wherein
an operational behavior of the machine is monitored, and
that an alarm signal is transmitted when a change in operational behavior is detected.

10. A protection system for protecting the use of a machine learning module, configured to carry out a method as claimed in claim 1.

11. A computer program product, comprising a computer readable hardware storage device having computer readable program code stored therein, the program code executable by a processor of a computer system to implement a method configured for implementing a method as claimed in claim 1.

12. A machine-readable storage medium having a computer program as claimed in claim 11.
